(19) United States
(12) Patent Application Publication
(10) Pub. No.: US 2006/0017282 A1
(43) Pub. Date: Jan. 26, 2006

(54) Arrangement for connecting a rigid tube to a flexible tube

(75) Inventors: Patrick Claus, Haute Vigneulles (FR); Lionel Champion, Metz (FR)

Correspondence Address: YOUNG & BASILE, P.C., 3001 WEST BIG BEAVER ROAD, SUITE 624, TROY, MI, 48084, US

(73) Assignee: ITT Manufacturing Enterprises, Inc., Wilmington, DE (US)

(21) Appl. No.: 11/129,187

(22) Filed: May 13, 2005

(30) Foreign Application Priority Data
May 14, 2004 (FR) FR 0450948

(51) Int. Cl. F16L 43/00

(52) U.S. Cl. 285/179

(57) ABSTRACT

The invention proposes an arrangement for connecting a rigid tube to a flexible tube, of the type in which an upstream end section of the rigid tube is pushed coaxially into a complementary downstream end section of the flexible tube, and of the type which comprises a tubular sleeve which extends coaxially around the downstream end section of the flexible tube and is crimped radially onto the flexible tube to fix the rigid tube to the flexible tube by radial clamping, characterized in that the sleeve and the upstream end section of the rigid tube are curved at least in part and with more or less the same radius of curvature.

### BACKGROUND OF THE INVENTION

The invention proposes an arrangement for connecting a rigid tube to a flexible tube.

More particularly, the invention proposes an arrangement for connecting a rigid tube to a flexible tube, of the type in which an upstream end section of the rigid tube is pushed coaxially into a complementary downstream end section of the flexible tube, and of the type which comprises a tubular sleeve which extends coaxially around the downstream end section of the flexible tube and is crimped radially onto the flexible tube to fix the rigid tube to the flexible tube by radial clamping.

Rigid tubes connected to flexible tubes are used particularly in automotive construction, for producing the braking circuit connecting the vehicle brakes to the master cylinder.

The rigid tubes are formed by bending so as to suit the various forms of the vehicle and so that the braking circuit does not impede the installation of the other components of the vehicle within the chassis.

The flexible tubes are used so that the braking circuit can be deformed, thus simplifying the fitting of the circuit to the vehicle, and allowing a part fixed to the body of the vehicle, such as the master cylinder for example, to be connected to a part that can move with respect to the body, such as a brake caliper mounted on a wheel of the vehicle for example.

Document GB-A-2 336 636 describes a braking circuit comprising two rigid tubes connected by a flexible tube, and an arrangement for connecting an upstream end section of a rigid tube to a complementary downstream end section of the flexible tube.

However, with this arrangement, the upstream end section of the rigid tube, the complementary downstream end section of the flexible tube and the sleeve are straight.

In addition, the flexible tube in this circuit is bent.

In order to limit the deformation of the flexible tube, it has been proposed for the rigid tube to be bent in the region of the arrangement which is situated on the rigid tube, downstream of the arrangement.

In addition, this bend in the rigid tube is situated a certain distance away from the arrangement, which distance is dependent in particular on the method used to produce the bend.

Thus, a straight section of the rigid tube and the arrangement which is also straight extend between the flexible tube and the bend, and that accordingly increases the bulk of the circuit in the region of the arrangement.

### SUMMARY OF THE INVENTION

It is an object of the invention to propose an arrangement for connecting a rigid tube to a flexible tube for which the bend in the rigid tube is situated near the flexible tube.

To this end, the invention proposes an arrangement of the type described hereinabove, characterized in that the sleeve and the upstream end section of the rigid tube are curved at least in part and with more or less the same radius of curvature.

According to other features of the invention:
the sleeve and the upstream end section of the rigid tube are produced by bending, before they are assembled;
the upstream end section of the rigid tube comprises at least one straight portion and one curved portion which run on from one another, and the sleeve comprises a straight part situated in line with the straight portion of the upstream end section of the rigid tube which is deformed radially so as to crimp the sleeve;
the upstream end section of the rigid tube comprises two straight upstream and downstream end portions connected by the curved portion, and the sleeve comprises two straight upstream and downstream end parts, each situated in line with an associated straight portion of the upstream end section of the rigid tube;
the downstream end of the sleeve comprises an internal radial flange which is in abutment in the downstream direction against a radial bulge on the downstream end of the upstream end section of the rigid tube;
the upstream end of the upstream end section of the rigid tube has a radial bulge;
the radius of curvature is equal to twice the diameter of the sleeve;
   the radius of curvature is equal to three times the diameter of the sleeve;
   the upstream end section of the rigid tube can be pushed coaxially into the sleeve before it is pushed coaxially into the downstream end section of the flexible tube.

### BRIEF DESCRIPTION OF THE DRAWINGS

Other features and advantages of the invention will become apparent from reading the detailed description which follows, for an understanding of which reference will be made to the attached figures among which:

FIG. 1 is a schematic perspective depiction of an arrangement according to the invention;

FIG. 2 is an axial section through the arrangement depicted in FIG. 1;

FIG. 3 is a view similar to that of FIG. 2, in which the rigid tube and the sleeve are fitted before the flexible tube is fitted.

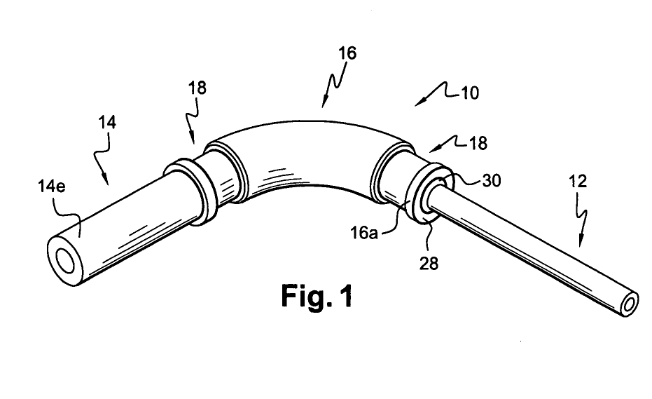

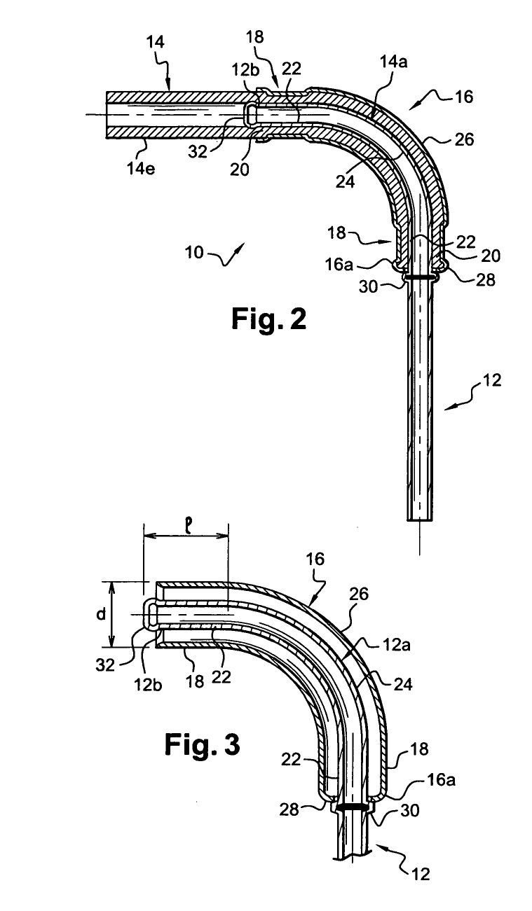

### DETAILED DESCRIPTION OF THE PREFERRED EMBODIMENT

In the description which follows, elements that are identical, similar or analogous will be denoted by the same reference numerals.

The figures depict an arrangement 10 for connecting a rigid tube 12 to a flexible tube 14, in which an upstream end section 12a of the rigid tube 12 is pushed coaxially into a downstream end section 14a of the flexible tube 14.

The arrangement 10 also comprises a tubular sleeve 16 which extends coaxially around the downstream end section 14a of the flexible tube 14, and therefore coaxially around the upstream end section 12a of the rigid tube 12, and which is crimped radially onto the downstream end section 14a of the flexible tube 14 so as to fix the rigid tube 12 to the flexible tube 14.

To do this, the sleeve 16 comprises two upstream and downstream end parts 18 which are deformed radially by performing the crimping of two associated portions 20 of the downstream end section 14a of the flexible tube 14 onto two portions 22 of the upstream end section 12a of the rigid tube 12.

Crimping the sleeve 16 also allows the connection to be a sealed one.

In accordance with the invention and as can be seen in greater detail in FIG. 3, the upstream end section 12a of the rigid tube 12 and the sleeve 16 are partially bent, which makes it possible to reduce the space required by the arrangement 10 if the braking circuit has an elbow situated in the region of the downstream end section 14a of the flexible tube 14.

In this instance, the upstream end section 12a of the rigid tube 12 and the sleeve 16 are bent at right angles. However, it will be understood that the invention is not restricted to this embodiment of the arrangement and that the angle of bending may have any other magnitude.

As can be seen in FIG. 3, the upstream end section 12a of the rigid tube 12, which is bent in accordance with the invention, comprises two upstream and downstream straight portions 22 which are connected by a bent portion 24.

The upstream and downstream straight portions 22 each extend in the region of a respective upstream or downstream end of the upstream end section 12a of the rigid tube 12.

The sleeve 16 according to the invention, which is itself also bent, comprises two straight parts 18 and a bent part 26 connecting the straight parts.

According to another aspect of the invention, the upstream end section 12a of the rigid tube 12 and the sleeve 16 are bent with more or less the same radius of curvature. This allows the upstream end section 12a of the rigid tube 12 and the sleeve 16 to be effectively coaxial.

The straight parts 18 of the sleeve 16 in this case are the upstream and downstream end parts of the sleeve 16, which are deformed radially so as to crimp the sleeve 16.

Thus, each straight part 18 of the sleeve 16 is situated in line with a straight portion 22 of the upstream end section 12a of the rigid tube 12.

This makes it possible to have uniform clamping of the portions 22 of the end section between the straight parts 18 of the sleeve 16 and the straight portions 22 of the upstream end section 12a of the rigid tube 12.

In addition, in order to improve the coaxiality of the assembly, the bent part 26 of the sleeve 16 is situated in line with the curved portion 24 of the upstream end section 12a of the rigid tube 12.

According to another aspect of the invention that makes it possible to simplify the method of producing the arrangement 10, the upstream end section 12a of the rigid tube 12 and the sleeve 1 are formed individually by bending before they are assembled.

This is because the bending of a tubular element, that is to say in this case the bending of the rigid tube 12 and of the sleeve 16 requires special-purpose tooling so as to avoid kinking the part that is to be bent. In consequence, simultaneous bending of the downstream end section 12a of the rigid section 12 and of the sleeve 16 would require the use of special-purpose tooling that is excessively expensive.

The radius of curvature of the upstream end section 12a of the rigid tube 12 and of the sleeve 16 are determined as a function of the dimensions of the straight portions 22 of the upstream end section 12a of the rigid tube 12, so as to allow the entirety of the upstream end section 12a of the rigid tube 12 to be introduced coaxially into the sleeve 16.

The radius of curvature is in particular determined as a function of the length “l” of the straight portions 22 of the upstream end section 12a of the rigid tube 12 and as a function of the inside diameter “d” of the sleeve 16.

Thus, according to a first embodiment of the invention, the radius of curvature is twice the diameter of the sleeve 16, and according to another embodiment of the invention, the radius of curvature is equal to three times the diameter of the sleeve 16.

As can be seen in FIG. 3, the positioning of the sleeve 16 with respect to the upstream end section 12a of the rigid tube 12, along its main axis, is achieved by means of an internal radial flange 28 of the downstream end 16a of the sleeve 16 which is in abutment against a radial bulge 30 of the downstream end of the upstream end section 12a of the rigid tube 12.

In this instance, the upstream end section 12a of the rigid tube 12 is introduced into the sleeve 16 through a movement from the downstream to the upstream direction, with reference to FIG. 3. In consequence, the flange 28 is in abutment in the downstream direction against the bulge 30.

Once the sleeve 16 has been mounted around the upstream end section 12a of the rigid tube 12, the downstream end section 14a of the flexible tube 14 is pushed around the upstream end section 12a of the rigid tube 12.

The flexibility of the flexible tube 14 allows the downstream end section 14a of the flexible tube 14 to adopt the same curvature as the upstream end section 12a of the rigid tube 12 and as the sleeve 16.

The downstream end section 14a of the flexible tube 14 is pushed around the upstream end section 12a of the rigid tube 12 until its downstream end comes into abutment against the flange 28 of the sleeve 16, at the same time immobilizing the sleeve 16 between the downstream end of the downstream end section 14a of the flexible tube 14 and the radial bulge 30 of the rigid tube 12.

The upstream end 12b of the upstream end section 12a of the rigid tube 12 also comprises a second external radial bulge 32 which causes a local radial deformation of the downstream end section 14a of the flexible tube 14 so as to hold the downstream end section 14a of the flexible tube 14 in position with respect to the upstream end section 12a of the rigid tube 12.

Next, in a final step of assembling the arrangement 10 according to the invention, the straight parts 18 of the sleeve 16 are crimped radially onto the downstream end section 14a of the flexible tube 14, to clamp the downstream end section 14a of the flexible tube 14 onto the upstream end section 12a of the rigid tube 12.

The arrangement 10 according to the invention is particularly well suited to motor vehicle braking circuits in which the fluid pressure is sometimes very high.

To prevent the flexible tube 14 from expanding radially under the effect of the pressure, and according to an alternative form of embodiment of the invention (not depicted), the outer cylindrical wall 14e of the flexible tube 14 is covered with a metal sheath, or braid, of known type, which is configured in such a way as to prevent the flexible tube 14 from deforming radially.

In order to prevent the sheath from sliding coaxially with respect to the flexible tube, at least the upstream straight part 18 of the sleeve 16 is crimped onto one end of the sheath.

The arrangement 10 according to the invention makes it possible to bend a section of the rigid tube 12 where it connects with the flexible tube, thus simplifying the design of the braking circuit.

1. Arrangement for connecting a rigid tube to a flexible tube, of the type in which an upstream end section of the rigid tube is pushed coaxially into a complementary downstream end section of the flexible tube, and of the type which comprises a tubular sleeve which extends coaxially around the downstream end section of the flexible tube and is crimped radially onto the flexible tube to fix the rigid tube to the flexible tube by radial clamping, characterized in that the sleeve and the upstream end section of the rigid tube are curved at least in part and with more or less the same radius of curvature.

2. Arrangement according to claim 1, characterized in that the sleeve and the upstream end section of the rigid tube are produced by bending, before they are assembled.

3. Arrangement according to claim 1, characterized in that the upstream end section of the rigid tube comprises at least one straight portion and one curved portion which run on from one another, and in that the sleeve comprises a straight part situated in line with the straight portion of the upstream end section of the rigid tube which is deformed radially so as to crimp the sleeve.

4. Arrangement according to claim 1, characterized in that the upstream end section of the rigid tube comprises two straight upstream and downstream end portions connected by the curved portion, and in that the sleeve comprises two straight upstream and downstream end parts, each situated in line with an associated straight portion of the upstream end section of the rigid tube.

5. Arrangement according to claims claim 1, characterized in that the downstream end of the sleeve comprises an internal radial flange which is in abutment in the downstream direction against a radial bulge on the downstream end of the upstream end section of the rigid tube.

6. Arrangement according to claim 1, characterized in that an upstream end of the upstream end section of the rigid tube has a radial bulge.

7. Arrangement according to claim 1, characterized in that the radius of curvature is equal to twice the diameter of the sleeve.

8. Arrangement according to of claim 1, characterized in that the radius of curvature is equal to three times the diameter of the sleeves.

9. Arrangement according to claim 1, characterized in that the upstream end section of the rigid tube can be pushed coaxially into the sleeve before it is pushed coaxially into the downstream end section of the flexible tube.
